(19) United States
(12) Patent Application Publication
(10) Pub. No.: US 2005/0081352 A1
(43) Pub. Date: Apr. 21, 2005

(54) Device for removing modular concrete forms

(76) Inventor: Eugene Gargiulo, Durham, CT (US)

Correspondence Address: MCCORMICK, PAULDING & HUBER LLP, CITY PLACE II, 185 ASYLUM STREET, HARTFORD, CT, 06103, US

(21) Appl. No.: 10/838,802

(22) Filed: May 4, 2004

(30) Foreign Application Priority Data
Oct. 16, 2003 (WO) PCT/US03/32811

(51) Int. Cl. B23P 19/04

(52) U.S. Cl. 29/254

(57) ABSTRACT

A device for removing modular forms comprises an elongated shaft having a rearward end and a forward end. A pulling head is fixedly coupled to a forward end of the shaft. The pulling head engages a form to be removed from a wall. A slide hammer is slidably coupled to the shaft for generating an impact force to the form via the pulling head to thereby break a bond between the form and the wall.

### FIELD OF THE INVENTION

This invention relates generally to tools used in building construction, and more particularly relates to a device for removing modular forms from underlying rigid concrete.

### BACKGROUND

Stripping plywood style forms from freshly poured walls is problematic in the amount of time needed to break the form loose and remove it from the wall. Using conventional means such as, for example, a carpenters hammer or crowbar, the removal operation takes approximately 20-25 seconds to chip away the concrete from around the form tie, snap off the end of the tie, gouge the claw end of the hammer into the side of the form, pry it up away from the wall slightly, slide the claw end of the hammer between the wall and form to pry against the face of the form to break it free, and then remove the form and place it on the ground.

Other drawbacks with the above-mentioned removal operation include excessive time needed to remove inside corner forms, damage to the steel corner forms from having to hammer them to break them free from the wall, damage to the edges of the plywood forms from gouging the claw end of the hammer into it—effectively making the form thicker at the edges so as to make obtaining a smooth transition from the face of one form to the adjacent form difficult. The end results are an uneven surface of the wall when the forms are removed, damage such as gouges and roughness to the face of the forms from prying against it to break it away from the wall (resulting in undesirable blemishes on the finished surface of the wall), and additional expense to the contractor for having to repair the surface of the wall, recondition the face of the forms, or replace the forms prematurely because of excessive wear and tear created by destructive stripping methods.

Accordingly, it is a general object of the present invention to overcome the drawbacks of prior tools for removing forms from walls.

### SUMMARY OF THE INVENTION

A device for removing modular forms comprises an elongated shaft having a rearward end and a forward end. A pulling head is coupled to a forward end of the shaft for engaging a form to be removed from a wall. A slide hammer, having a weight of, for example, approximately ten pounds, is slidably coupled to the shaft for generating an impact force to the form via the pulling head to thereby break a bond between the form and the wall. A stop member is located adjacent to the rearward end of the shaft to prevent the slide hammer from moving beyond the stop member toward the rearward end and to create the impact force to the form when the slide hammer strikes the stop member. The device preferably includes a handle coupled to the rearward end of the shaft for the operator to grip with one hand while grasping the slide hammer with the other hand. The handle, for example, can include a pin extending through the shaft in a direction generally perpendicular to a length of the shaft. The slide hammer preferably includes a gripping portion and guard members extending outwardly at longitudinal ends thereof for protecting the hand of the operator while grasping the gripping portion. Preferably, the pulling head defines a bore at a rear portion for being received over the forward end of the shaft.

In a first aspect of the present invention, the pulling head includes a forward portion having a forward surface facing in a direction generally away from the shaft. The forward surface defines an open-ended slot for receiving and retaining therein a form lever stud.

In a second aspect of the present invention, the pulling head includes a rear portion for being coupled to a forward end of the shaft, and a forward portion including a projection spaced from the forward portion for being received in an opening defined along an edge of a form to be removed. The projection can include a generally flattened pin for engaging flattened slots defined along an edge of SYMONS steel frame forms or other compatible forms. Alternatively, the projection can include a generally cylindrical pin for engaging round holes defined along an edge of DURAND aluminum frame forms or other compatible forms.

In a third aspect of the present invention, the pulling head includes a rear portion for being coupled to a forward end of the shaft, and a forward portion including an engagement member defining a channel for being received over an edge of a form. Preferably, the engagement member includes an upper wall, and first and second sidewalls cooperating with one another to define the channel. The pulling head and the shaft can cooperate with one another such that the shaft extends downwardly at an angle relative to the horizontal of, for example, approximately 30 degrees, when the engagement member is in an orientation to engage an upper edge of a form. Alternatively, the pulling head and the shaft can cooperate with one another such that the shaft extends generally horizontally when the engagement member is in an orientation to engage an upper edge of a form.

### BRIEF DESCRIPTION OF THE DRAWINGS

FIG. 1 is a side view of a device for removing modular forms in accordance with the present invention.

FIG. 2 is a front perspective view of the pulling head of the device of FIG. 1.

FIG. 3 is a back perspective view of the pulling head of the device of FIG. 1.

FIG. 4 is a side view of a device for removing modular forms in accordance with a second embodiment of the present invention.

FIG. 5 is a first end view of a head of the device of FIG. 4.

FIG. 6 is an enlarged side view of a head of the device of FIG. 4.

FIG. 7 is a second end view of a head of the device of FIG. 4

FIG. 8 is a top view of a head of the device of FIG. 4.

FIG. 9 is a side view of a device for removing modular forms in accordance with a third embodiment of the present invention.

FIG. 10 is a first end view of a head of the device of FIG. 9.

FIG. 11 is an enlarged side view of a head of the device of FIG. 9.

FIG. 12 is a second end view of a head of the device of FIG. 9

FIG. 13 is a top view of a head of the device of FIG. 9.

FIG. 14 is a side view of a head of a device for removing modular forms in accordance with a fourth embodiment of the present invention.

FIG. 15 is a top view of the head of FIG. 14.

FIG. 16 is a side view of a head of a device for removing modular forms in accordance with a fifth embodiment of the present invention.

FIG. 17 is a top view of the head of FIG. 16.

### DETAILED DESCRIPTION OF THE PREFERRED EMBODIMENTS

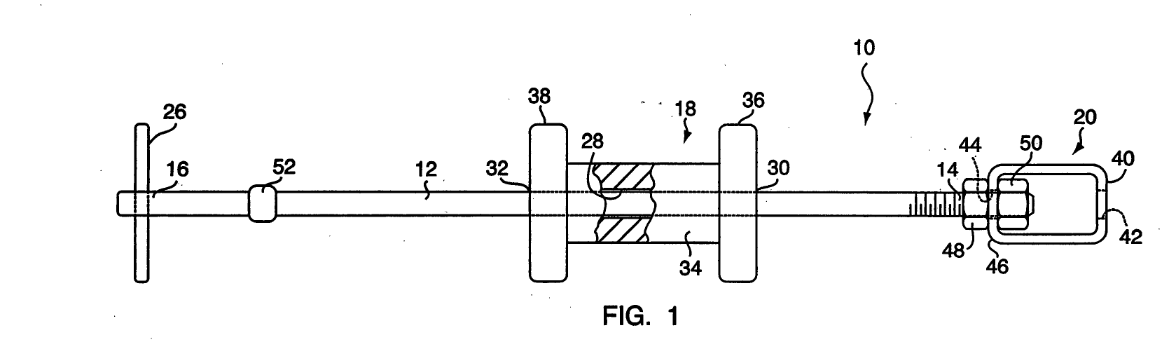

With reference to FIG. 1, a device for removing modular forms in accordance with the present invention is indicated generally by the reference number 10. The device 10 includes an elongated shaft 12 having a forward end 14 and a rearward end 16. A slide hammer 18 is slidably coupled to the shaft 12 for movement back and forth therealong generally between the forward end 14 and the rearward end 16. The shaft 12 is preferably cylindrical in cross section, but may take other cross-sectional forms such as being square or rectangular without departing from the scope of the present invention. A pulling head 20 is fixedly coupled to the shaft 12 at the forward end 14. The device 10 may include stop members located adjacent to the forward end 14 and the rearward end 16 of the shaft 12 for preventing the slide hammer 18 from moving along the shaft beyond the stop members as is explained more fully below. The device 10 may also include a handle 26 coupled to the rearward end 16 of the shaft 12 for gripping with one hand while moving the slide hammer 18 with the other hand. As shown in FIG. 1, the handle 26 may be in the form of a pin extending outwardly from the shaft 12, but may take other forms without departing from the scope of the present invention.

The slide hammer 18 defines a bore 28 extending therethrough from a first end 30 to a second end 32 for slidably receiving the shaft 12 within the bore. A cross-sectional area or diameter of the bore 28 is slightly larger than that of the shaft 12 for permitting the slide hammer 18 to easily move therealong while limiting lateral play of the slide hammer relative to the shaft. The slide hammer 18 has a substantial weight of, for example, about ten pounds, for generating a large impact force to a form to be removed from a wall. As shown in FIG. 1, the slide hammer 18 includes a gripping portion 34 and is preferably interposed between guard members 36, 38 extending radially outwardly from the gripping portion for protecting the hand of a user.

The pulling head 20 includes a forward portion 40 defining an open-ended slot 42 for engaging a form lever stud. The pulling head 20 also defines an opening 44 at a rear portion 46 for being received over the forward end 14 of the shaft 12. The pulling head 20 is fixedly coupled to the forward end 14 of the shaft 12 with, for example, retaining lock nuts 48, 50 threadably received along the shaft adjacent to each side of the opening 44 of the pulling head. The retaining lock nut 48 located on the shaft 12 adjacent to the forward end 14 thereof and rearwardly of the opening 44 of the pulling head 20 serves as a first stop member to prevent the slide hammer 18 from moving beyond the first stop member toward the forward end 14 of the shaft.

A second stop member 52 may be fixedly disposed along the shaft 12 adjacent to the rearward end 16. The second stop member 52 includes a portion having a larger cross-sectional area or diameter relative to that of the bore 28 of the slide hammer 18 to prevent the slide hammer from moving beyond the second stop member toward the rearward end 16 of the shaft 12.

In operation, the open-ended slot 42 defined by the forward portion 40 of the pulling head 42 slides over and engages a form lever stud of a modular form to be removed from a wall. The pulling head 20 uses the stud as a pulling point to remove the form from the wall, thereby generally eliminating the damage otherwise caused by the gouging of the claw of a conventional hammer or crowbar. A user of the device 10 grasps the gripping portion 34 of the slide hammer 18 with one hand and may grasp the handle 26 with the other hand. The user rapidly moves the slide hammer 18 back and forth along the shaft 12 one or more times as necessary to remove the form from the wall.

During each stroke of the slide hammer 18 toward the forward end 14 of the shaft 12, the slide hammer optionally can be moved far enough along the shaft to impact against the first stop member 48 to suddenly stop the forward movement of the slide hammer. The substantial weight of the slide hammer 18 suddenly stopping against the first stop member 48 generates a large impact force which is propagated forwardly from the shaft 12 to the pulling head 20 to thereby deliver the impact force to the form to be removed. Several such impact forces causes the form to rapidly vibrate relative to the wall so as to weaken and break the bond between the form and the wall.

During each stroke of the slide hammer 18 toward the rearward end 16 of the shaft 12, the impact of the slide hammer against the second stop member 52 suddenly stops the rearward movement of the slide hammer. The substantial weight of the slide hammer 18 suddenly stopping against the second stop member 52 generates a large impact force which is propagated from the shaft 12 to the pulling head 20 to thereby deliver the impact force to the form to be removed. Several such impact forces causes the form to rapidly vibrate relative to the wall so as to weaken and break the bond between the form and the wall. Once the bond is weakened, the operator can pull the form free from the wall by pulling on the handle 26 or by grasping the form with the operator's hands.

Employing a device for removing modular forms in accordance with the present invention significantly reduces the time to remove a form from a wall relative to conventional devices from 20-25 seconds to 6-8 seconds. Eliminating the damage otherwise caused by the use of conventional removal techniques not only decreases the removal time by about 67% to about 75%, but also eliminates the other above-mentioned problems created by the use of conventional removal methods.

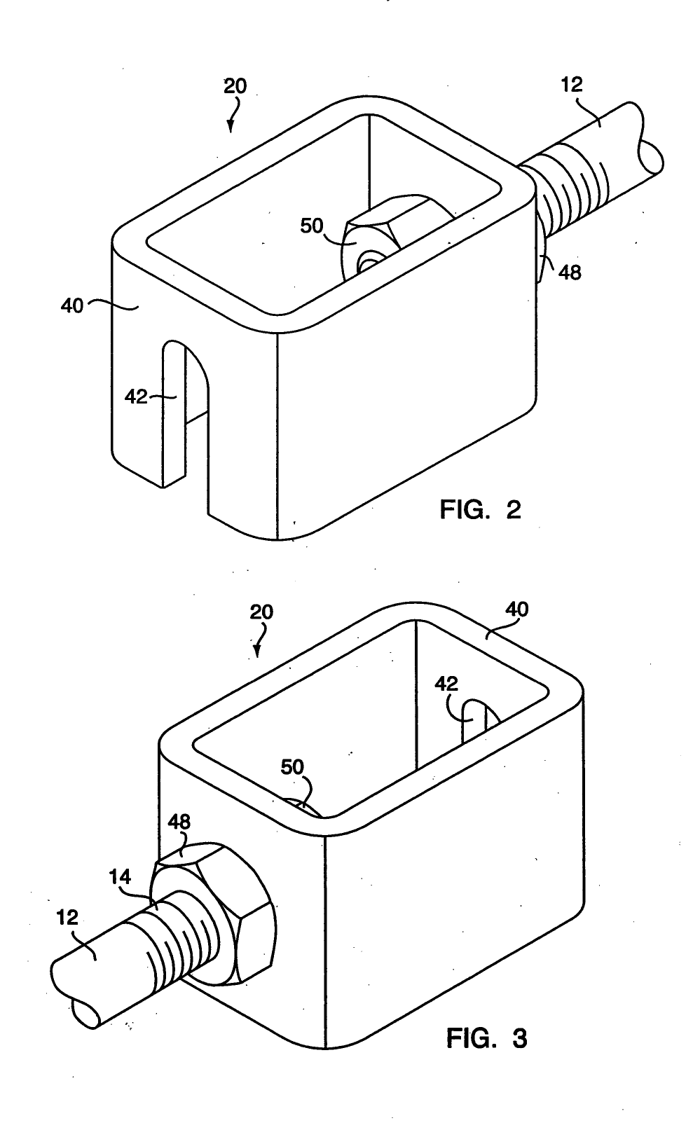

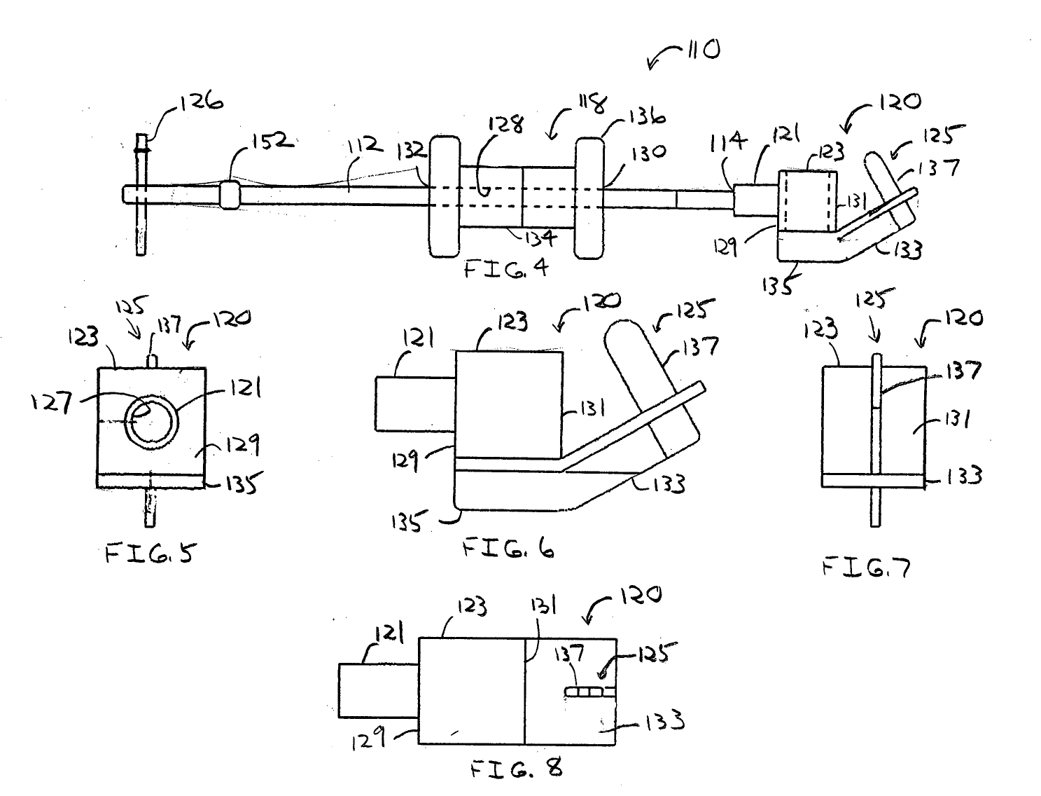

With reference to FIGS. 4-8, a device for removing modular forms in accordance with a second embodiment of the present invention is indicated generally by the reference number 110. Like elements with the device shown in FIGS. 1-3 are indicated by like reference numbers preceded by “1”. The device 110 is generally the same as the device 10 except for the pulling head. Accordingly, the device 110 and its operation will be described in detail only with respect to the structure that is different from that of the device 10.

A pulling head 120 is fixedly coupled to a shaft 112 at the forward end 114. The pulling head 120 includes a neck 121, an abutment member 123 and a projection 125. The neck 121 defines a threaded bore 127 for being threadably received on the shaft 112 at a forward end 114 thereof. A first side 129 of the abutment member 123 is coupled to the neck 121, and a second side 131 of the abutment member, generally facing a direction opposite to that of the first side, is for abutting against a face of a form to be removed. An overhanging member 133 extends outwardly from an upper end 135 of the abutment member 123 in a direction generally away from the second side 131 thereof. As shown in FIGS. 4 and 6, the overhanging member 133 extends downwardly at an angle of approximately 30 degrees relative to a plane defined by the upper end 135 of the abutment member 123, but can lie in the same plane as the upper end or extend outwardly therefrom at other various angles without departing from the scope of the present invention. The projection 125 includes a generally flattened pin 137, preferably of hardened steel, mounted to and extending outwardly from the overhanging member 133 in a direction generally transverse to a plane defined by the overhanging member.

The pulling head 120 of the device 110 is designed for removing SYMONS steel frame forms or other compatible forms that define generally flattened slots along an upper surface thereof. The pin 137 is inserted into a slot in the steel frame of a form along an upper surface thereof. The angle of the overhanging member 133 relative to a central axis of the neck 121 and the shaft 112 attached to the neck permits the pin 137 to be easily inserted in a slot at an upper end of a form that is above the operator's head, and permits the shaft to extend downwardly at an angle relative to the horizontal from the forward end 114 of the shaft toward the handle end of the shaft in order to permit the operator to move the slide hammer 118 at a comfortable and accessible level.

In operation, to remove the first form on a wall, the pin 137 is inserted in a center slot of the steel frame of the form at an upper end thereof. The slide hammer 118 is then moved along the shaft 112 until the slide hammer impacts against the stop member 152. When the slide hammer 118 impacts the stop member 152 adjacent to the handle end of the device 110, the impact creates a shock that will help “pop” the form free from the wall. Several such “pops” may be needed to completely remove the form from the wall. Once the first form is removed, the pin 137 is then inserted into the left or right hand slot in the top of the form that is to be removed next. If an operator is stripping forms in a direction to the left, the pin 137 is inserted in the slot furthest to the left. If the operator is stripping forms in a direction to the right, the pin 137 is inserted in the slot furthest to the right. Either way, the device 110 will be located to the side of the form that is in the direction that the operator is stripping the wall.

In order to remove inside corners, the pin 137 of the device 110 is inserted onto the top of the corner or into a slot on the side of the corner—preferably the highest or lowest slot. The form ties need to be broken off or bent back away from the corner form in order for the device to be able to completely remove the form from the wall.

Although the pulling head 120 of the device 110 is shown and described in an exemplary embodiment by way of example, it should be understood that the pulling head can take other various forms without departing from the scope of the present invention. For example, the neck 121 can be eliminated such that the pulling head 120 is directly or otherwise permanently coupled to the shaft. Moreover, the abutment member 123 can be eliminated such that the overhanging member 133 is directly coupled to the neck 121 or the shaft 112.

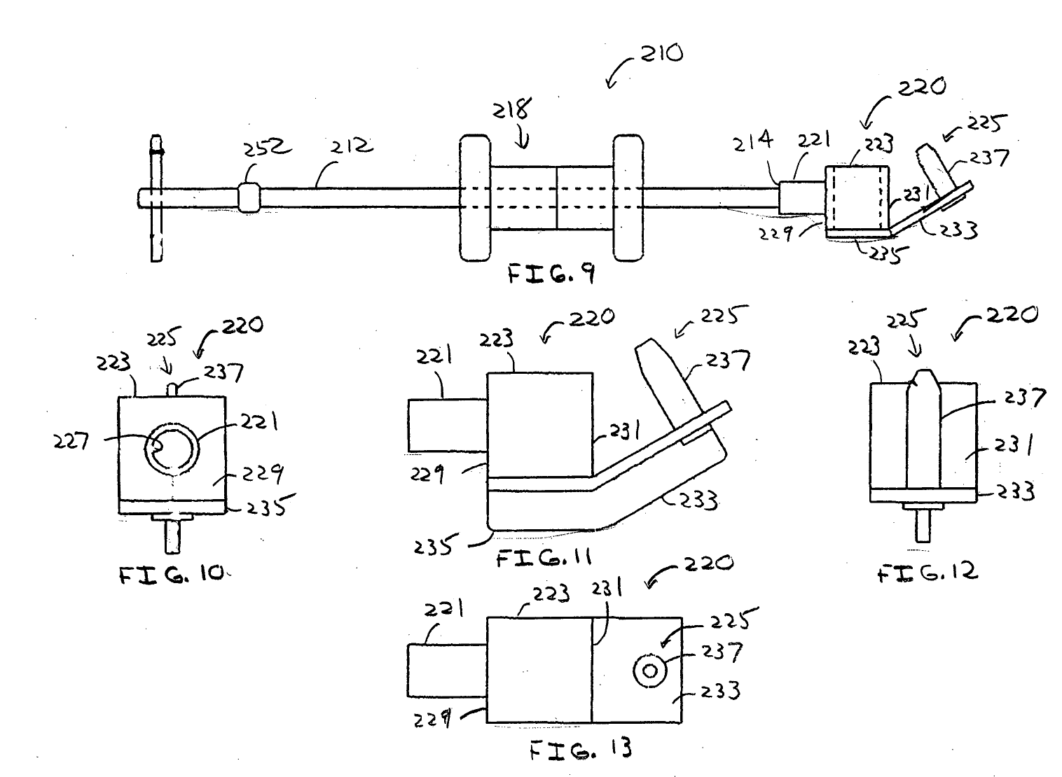

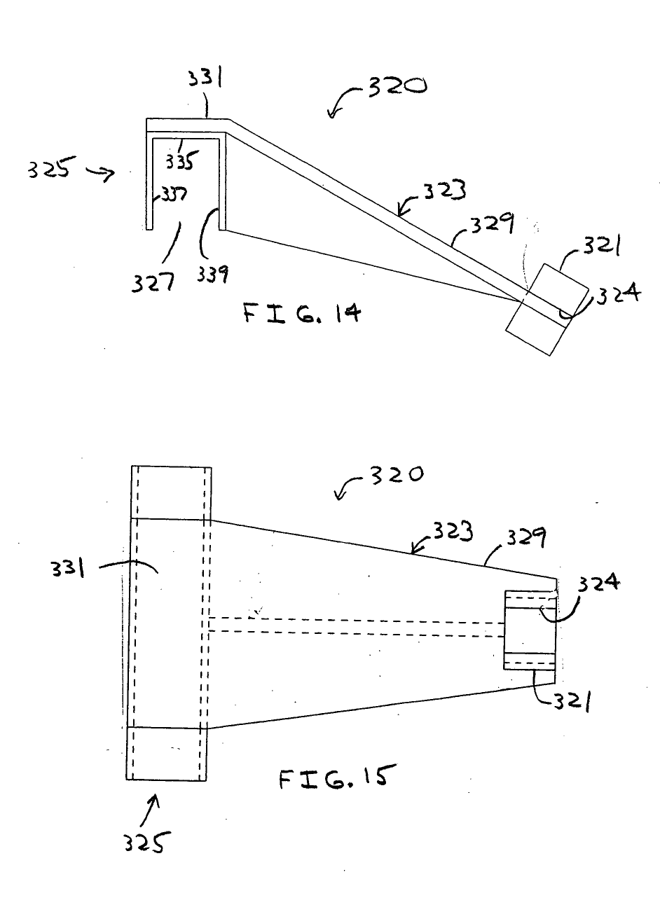

With reference to FIGS. 9-13, a device for removing modular forms in accordance with a third embodiment of the present invention is indicated generally by the reference number 210. Like elements with the device shown in FIGS. 1-3 are indicated by like reference numbers preceded by “2”. The device 210 is generally the same as the device 10 except for the pulling head. Accordingly, the device 210 and its operation will be described in detail only with respect to the structure that is different from that of the device 10.

A pulling head 220 is fixedly coupled to a shaft 212 at the forward end 214. The pulling head 220 includes a neck 221, an abutment member 223 and a projection 225. The neck 221 defines a threaded bore 227 for being threadably received on the shaft 212 at a forward end 214 thereof. A first side 229 of the abutment member 223 is coupled to the neck 221, and a second side 231 of the abutment member, generally facing a direction opposite to that of the first side, is for abutting against a face of a form to be removed. An overhanging member 233 extends outwardly from an upper end 235 of the abutment member 223 in a direction generally away from the second side 231 thereof. As shown in FIGS. 9 and 11, the overhanging member 233 extends downwardly at an angle of approximately 30 degrees relative to a plane defined by the upper end 235 of the abutment member 223, but can lie in the same plane as the upper end or extend outwardly therefrom at other various angles without departing from the scope of the present invention. The projection 225 includes a generally round or cylindrical pin 237, preferably a ⅝″ hardened steel pin, mounted to and extending outwardly from the overhanging member 233 in a direction generally transverse to a plane defined by the overhanging member.

The pulling head 220 of the device 210 is designed for removing DURAND aluminum forms or other compatible forms that define generally round holes along an upper surface thereof. The pin 237 is inserted into a hole in the aluminum frame of a form along an upper surface thereof. The angle of the overhanging member 233 relative to a central axis of the neck 221 and the shaft 212 permits the pin 237 to be easily inserted in a hole at an upper end of a form that is above the operator's head, and permits the shaft to extend downwardly at an angle relative to the horizontal from the forward end 214 of the shaft toward the handle end of the shaft in order to permit the operator to move the slide hammer 218 at a comfortable and accessible level.

In operation, to remove the first form on a wall, the pin 237 is inserted in a center hole of the aluminum frame of the form at an upper end thereof. The slide hammer 218 is then moved along the shaft 212 until the slide hammer impacts against the stop member 252. When the slide hammer 218 impacts the stop member 252 adjacent to the handle end of the device 210, the impact creates a shock that will help “pop” the form free from the wall. Several such “pops” may be needed to completely remove the form from the wall. Once the first form is removed, the pin 237 is then inserted into the left or right hand hole in the top of the form that is to be removed next. If an operator is stripping forms in a direction to the left, the pin 237 is inserted in the hole furthest to the left. If the operator is stripping forms in a direction to the right, the pin 237 is inserted in the hole furthest to the right. Either way, the device 210 will be located to the side of the form that is in the direction that the operator is stripping the wall.

In order to remove inside corners, the pin 237 of the device 210 is inserted onto the top of the corner or into a hole on the side of the corner—preferably the highest or lowest hole. The form ties need to be broken off or bent back away from the corner form in order for the device to be able to completely remove the form from the wall.

Although the pulling head 220 of the device 210 is shown and described in an exemplary embodiment by way of example, it should be understood that the pulling head can take other various forms without departing from the scope of the present invention. For example, the neck 221 can be eliminated such that the pulling head 220 is directly or otherwise permanently coupled to the shaft. Moreover, the abutment member 223 can be eliminated such that the overhanging member 233 is directly coupled to the neck 221 or the shaft 212.

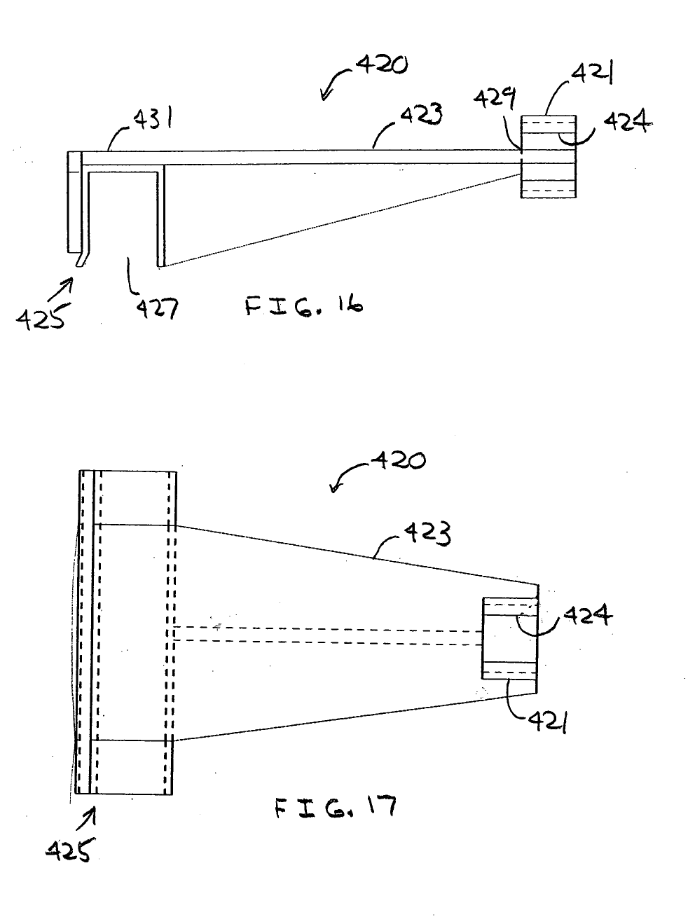

With reference to FIGS. 14 and 15, a pulling head for removing modular forms in accordance with a fourth embodiment of the present invention is indicated generally by the reference number 320. The pulling head 320 is for attaching to a shaft including a slide hammer assembly as previously described and shown in FIGS. 1, 4 and 9.

A device including the pulling head 320 is preferably used for removing plywood style forms that range in thickness up to 1-⅛″. There are several form manufacturers that produce forms on which the pulling head 320 can be effectively used. Some of the manufacturers are, for example, Gates, Advance, Simplex, Symons, Rapid-Form, Dura-Form and Four Seasons.

The pulling head 320 includes a neck 321, an extension member 323 and an engagement member 325 defining a channel 327. The neck 321 defines a threaded bore 324 for being threadably received on a shaft as shown in FIGS. 1, 4 and 9 at a forward end thereof. A first portion 329 of the extension member 323 is coupled to the neck 321, and a second portion 331 of the extension member supports the engagement member 325. As shown in FIG. 14, the first portion 329 of the extension member 323 extends downwardly at an angle of approximately 30 degrees relative to a plane defined by an upper surface of the first portion 329 of the extension member, but can lie in the same plane as an upper surface of the second portion 331 or extend outwardly therefrom at other various angles without departing from the scope of the present invention.

When in an operative position, the engagement member 325 depends generally downwardly from the second portion 331 of the extension member 323 and defines a downwardly facing open-ended channel 327 for being received over an upper end of a form to be removed from a wall. More specifically, the engagement member 325 includes an upper wall 335, and first and second side walls 337, 339 cooperating with one another to define the channel 327. As shown in FIG. 14, the side walls 337, 339 are spaced from one another in generally parallel relation, and each perpendicularly extend from the upper wall 335. The angle of the first portion 329 relative to the second portion 331 of the extension member 323 permits the engagement member 325 to be easily received over an upper end of a form that is above the operator's head, and permits the shaft to extend downwardly at an angle relative to the horizontal from the upper end of the shaft toward the handle end of the shaft in order to permit the operator to move the slide hammer at a comfortable and accessible level.

In operation, the channel 327 defined by the engagement member 325 is received over an upper end of the modular form to be removed. Once in place, the operator quickly pulls the slide hammer along the shaft until it makes contact with the stop member on the handle end of the device. The shock created by the slide hammer hitting the stop pops the form free from the wall—typically within a few pulls. The same procedure is used until all of the forms have been removed from the wall.

Although the pulling head 320 is shown and described in an exemplary embodiment by way of example, it should be understood that the pulling head can take other various forms without departing from the scope of the present invention. For example, the neck 321 can be eliminated such that the pulling head 320 is directly or otherwise permanently coupled to the shaft. Moreover, the extension member 323 can be eliminated such that the engagement member 325 is directly coupled to the neck 321 or the shaft.

With reference to FIGS. 16 and 17, a pulling head for removing modular forms in accordance with a fifth embodiment of the present invention is indicated generally by the reference number 420. The pulling head 420 is for attaching to a shaft including a slide hammer assembly as previously described and shown in FIGS. 1, 4 and 9.

A device including the pulling head 420 is preferably used for removing plywood style forms that range in thickness up to 1-⅛″. There are several form manufacturers that produce forms on which the pulling head 420 can be effectively used. Some of the manufacturers are, for example, Gates, Advance, Simplex, Symons, Rapid-Form, Dura-Form and Four Seasons.

The pulling head 420 includes a neck 421, an extension member 423 and an engagement member 425 defining a channel 427. The neck 421 defines a threaded bore 424 for being threadably received on a shaft as shown in FIGS. 1, 4 and 9 at a forward end thereof. The extension member 423 has a first longitudinal end 429 coupled to the neck 421, and a second longitudinal end 431 supporting the engagement member 425. As shown in FIG. 16, an upper portion of the extension member 423 is generally disposed in a plane that is parallel to a central axis of the bore 424 defined by the neck 421.

When in an operative position, the engagement member 425 depends generally downwardly from the extension member 423 and defines a downwardly facing open-ended channel 427 for being received over an upper end of a form to be removed from a wall. More specifically, the engagement member 425 includes an upper wall 435, and first and second side walls 437, 439 cooperating with one another to define the channel 427. As shown in FIG. 16, the side walls 437, 439 are spaced from one another in generally parallel relation, and each perpendicularly extend from the upper wall 435. Because the upper wall 435 of the extension member 423 lies in a plane that is parallel to a central axis of the bore 424 defined by the neck 421, a shaft when attached to the neck extends horizontally outwardly from the pulling head 420, as opposed to extending downwardly from the pulling head 320 shown in FIGS. 14 and 15. The horizontal orientation of a shaft attached to the pulling head 420 permits an operator to remove forms having an upper end elevated as high as six feet relative to the operator while standing on a concrete footing, or elevated forms that will be removed while the operator is standing on planking mounted off of the back side of the forms.

In operation, the channel 427 defined by the engagement member 425 is received over an upper end of the modular form to be removed. Once in place, the operator quickly pulls the slide hammer along the shaft until it makes contact with the stop member on the handle end of the device. The shock created by the slide hammer hitting the stop pops the form free from the wall—typically within a few pulls. The same procedure is used until all of the forms have been removed from the wall.

Although the pulling head 420 is shown and described in an exemplary embodiment by way of example, it should be understood that the pulling head can take other various forms without departing from the scope of the present invention. For example, the neck 421 can be eliminated such that the pulling head 420 is directly or otherwise permanently coupled to the shaft. Moreover, the extension member 423 can be eliminated such that the engagement member 425 is directly coupled to the neck 421 or the shaft.

As will be recognized by those of ordinary skill in the pertinent art, numerous modifications and substitutions may be made to the above-described embodiment of the present invention without departing from the scope of the invention. Accordingly, the preceding portion of this specification is to be taken in an illustrative, as opposed to a limiting sense.

1. A device for removing modular forms, comprising:
an elongated shaft having a rearward end and a forward end;
a pulling head coupled to a forward end of the shaft for engaging a form to be removed from a wall; and
a slide hammer slidably coupled to the shaft for generating an impact force to the form via the pulling head to thereby break a bond between the form and the wall.

2. A device as defined in claim 1, wherein the slide hammer has a weight of about ten pounds.

3. A device as defined in claim 1, further including a stop member located adjacent to the rearward end of the shaft to prevent the slide hammer from moving beyond the stop member toward the rearward end and to create the impact force to the form when the slide hammer strikes the stop member.

4. A device as defined in claim 1, further including a handle coupled to the rearward end of the shaft.

5. A device as defined in claim 4, wherein the handle includes a pin extending through the shaft in a direction generally perpendicular to a length of the shaft.

6. A device as defined in claim 1, wherein the slide hammer includes a gripping portion and guard members extending outwardly at longitudinal ends thereof for protecting the hand of a user while grasping the gripping portion.

7. A device as defined in claim 1, wherein the shaft is generally cylindrical.

8. A device as defined in claim 1, wherein the pulling head defines a bore at a rear portion for being received over the forward end of the shaft.

9. A device as defined in claim 8, further including lock nuts threadably received on the shaft at each side of the opening defined by the pulling head for fixedly coupling the pulling head to the shaft.

10. A device as defined in claim 1, wherein the pulling head defines a threaded bore at a rear portion for being received over the forward end of the shaft.

11. A device as defined in claim 1, wherein the pulling head includes a forward portion having a forward surface facing in a direction generally away from the shaft, the forward surface defining an open-ended slot for receiving and retaining therein a form lever stud of a form to be removed from a wall.

12. A device as defined in claim 1, wherein the pulling head includes a rear portion for being coupled to a forward end of the shaft, and a forward portion including a projection spaced from the forward portion for being received in an opening defined along an edge of a form to be removed.

13. A device as defined in claim 12, wherein the projection includes a generally flattened pin.

14. A device as defined in claim 12, wherein the projection includes a generally cylindrical pin.

15. A device as defined in claim 1, wherein the pulling head includes a rear portion for being coupled to a forward end of the shaft, and a forward portion including an engagement member for being coupled to an edge of a form.

16. A device as defined in claim 15, wherein the engagement member defines a channel for being received over an edge of a form.

17. A device as defined in claim 16, wherein the engagement member includes an upper wall, and first and second sidewalls cooperating with one another to define the channel.

18. A device as defined in claim 17, wherein the first and second sidewalls are spaced from one another in generally parallel relation, and each of the first and second sidewalls generally perpendicularly extends from the upper wall.

19. A device as defined in claim 15, wherein the pulling head and the shaft cooperate with one another such that the shaft extends downwardly at an angle relative to the horizontal when the engagement member is in an orientation to engage an upper edge of a form.

20. A device as defined in claim 15, wherein the pulling head and the shaft cooperate with one another such that the shaft extends downwardly at an angle of approximately 30 degrees relative to the horizontal when the engagement member is in an orientation to engage an upper edge of a form.

21. A device as defined in claim 15, wherein the pulling head and the shaft cooperate with one another such that the shaft extends generally horizontally when the engagement member is in an orientation to engage an upper edge of a form.

22. A device for removing modular forms, comprising:
an elongated shaft having a rearward end and a forward end;
a pulling head coupled to a forward end of the shaft for engaging a form to be removed from a wall, the pulling head including a forward portion having a forward surface facing in a direction generally away from the shaft, the forward surface defining an open-ended slot for receiving and retaining therein a form lever stud; and
a slide hammer slidably coupled to the shaft for generating an impact force to the form via the pulling head to thereby break a bond between the form and the wall.

23. A device for removing modular forms, comprising:
an elongated shaft having a rearward end and a forward end;
a pulling head coupled to a forward end of the shaft for engaging a form to be removed from a wall, the pulling head including a rear portion for being coupled to a forward end of the shaft, and a forward portion including a projection spaced from the forward portion for being received in an opening defined along an edge of a form to be removed; and
a slide hammer slidably coupled to the shaft for generating an impact force to the form via the pulling head to thereby break a bond between the form and the wall.

24. A device as defined in claim 23, wherein the projection includes a generally flattened pin.

25. A device as defined in claim 23, wherein the projection includes a generally cylindrical pin.

26. A device for removing modular forms, comprising:
an elongated shaft having a rearward end and a forward end;
a pulling head including a rear portion coupled to a forward end of the shaft, and a forward portion including an engagement member for being coupled to an edge of a form; and
a slide hammer slidably coupled to the shaft for generating an impact force to the form via the pulling head to thereby break a bond between the form and the wall.

27. A device as defined in claim 26, wherein the engagement member defines a channel for being received over an edge of a form.

28. A device as defined in claim 26, wherein the engagement member includes an upper wall, and first and second sidewalls cooperating with one another to define a channel for being received over an edge of a form.

29. A device as defined in claim 28, wherein the first and second sidewalls are spaced from one another in generally parallel relation, and each of the first and second sidewalls generally perpendicularly extends from the upper wall.

30. A device as defined in claim 26, wherein the pulling head and the shaft cooperate with one another such that the shaft extends downwardly at an angle relative to the horizontal when the engagement member is in an orientation to engage an upper edge of a form.

31. A device as defined in claim 26, wherein the pulling head and the shaft cooperate with one another such that the shaft extends downwardly at an angle of approximately 30 degrees relative to the horizontal when the engagement member is in an orientation to engage an upper edge of a form.

32. A device as defined in claim 26, wherein the pulling head and the shaft cooperate with one another such that the shaft extends generally horizontally when the engagement member is in an orientation to engage an upper edge of a form.
